(19) United States
(12) Patent Application Publication
(10) Pub. No.: US 2009/0037284 A1
(43) Pub. Date: Feb. 5, 2009

(54) POINT OF SALE SYSTEM WITH ABILITY TO REMOTELY UPDATE FIRMWARE

(75) Inventors: William E. Lewis, Fort Lauderdale, FL (US); Tara Kravit, Coconut Creek, FL (US); Kevin A. McNish, Coconut Creek, FL (US); Susan Young, Nashville, TN (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/831,743

(22) Filed: Jul. 31, 2007

(51) Int. Cl. G06Q 20/00

(52) U.S. Cl. 705/16

(57) ABSTRACT

A point of sale system comprises a microprocessor system, a peripheral interface, and a communication interface. The point of sale system is configured to receive, through the communication interface, an update to peripheral operation software associated with a peripheral device that may be connected to the peripheral interface. The peripheral device may be a contactless reader. The updated software may be received from a terminal management system connected to the point of sale device through the communication interface. The updated software may comprise a peripheral driver that is stored in memory comprised in the point of sale device. The updated software may comprise peripheral firmware that is stored in memory comprised in the peripheral device.

### BACKGROUND OF THE INVENTION

A point of sale (POS) device is a device used for processing various forms of payment at a point of sale. For example, a department store or other kind of merchant may have a POS device next to each cash register and use it for processing payments made by credit card, debit card, gift card, or other kinds of cards. A POS device often includes a slot for reading information from cards “swiped” through the system.

During the course of a transaction, the merchant indicates the amount of a purchase a customer wishes to make. Once a card is read and the amount entered, the POS device contacts a payment processing system. For example, the POS device may contain a modem and may contact a payment processing computer by dialing a telephone number and communicating with the payment processing computer through the modem. Or, the POS device may include a computer network interface, such as a connection to the Internet, and may communicate with the payment processing computer directly through the network. Or, the POS device may communicate with the payment processing Computer wirelessly, for example through a wireless carrier based connection.

The payment processing computer determines, based on the proposed purchase amount and account identification information read from the card, whether the customer has sufficient funds or credit to make the proposed purchase, and communicates the result to the POS device. In determining whether to authorize a purchase, the payment processing computer may contact one or more other computer systems for information. Once a purchase is approved, the merchant can indicate that funds should be transferred from an account or credit extended, and the sale can be finalized.

During many purchase transactions, the customer is required to sign a document or to enter a personal identification number (PIN). One of the reasons for these requirements is to increase the merchant's confidence that the customer at the cash register is actually the account holder authorized to make purchases, and not someone attempting to make a fraudulent purchase. While these measures do mitigate risk for the merchant and card issuer, they also take significant time and add to the complexity of making purchases. When the purchase is small and it is desirable to complete a transaction quickly, the added complexity and time burden may outweigh the small financial risk that a purchase is fraudulent. For example, requiring a customer signature at the drive-up window of a drive-through restaurant can seriously affect the throughput of the drive-through.

To address these kinds of transactions, “contactless” payment systems have been developed. These systems allow non-cash payment without a physical connection between a consumer payment device and a POS device. For example, the consumer payment device may be a card, key fob, watch, a cellular phone, or another kind of handheld device that is associated with value. The value may be in the form of stored value in an account, such as a checking account associated with a debit card, or may be in the form of credit. The payment device and the POS device can communicate without physical contact, often using a wireless method such as radio frequency (RF) communication, near field communication (NFC), a Bluetooth protocol, or a carrier-based mobile technology. To initiate communication, the customer taps the payment device on a contactless reader device associated with a POS device, or even simply waves the payment device in the vicinity of the contactless reader device. The POS device nearly instantaneously detects the presence of the payment device and reads the account information from the payment device. An authorization check is performed and the transaction can be approved and finalized in seconds. In some cases, no PIN or signature may be required, depending on merchant configuration. The customer can be on his way quickly and the merchant can begin another transaction with another customer.

Different contactless payment systems use different communication methods, and new systems are continually under development. A contactless reader device designed to read one or more existing kinds of payment devices may not be able to read newly-developed payment devices or payment devices with new formats. Replacing or rebuilding the POS device or contactless reader device so that it can be used with new devices is costly and time consuming.

### BRIEF SUMMARY OF THE INVENTION

In one example embodiment, a method of updating software comprises requesting, by a point of sale (POS) device, and update of peripheral operation software from a terminal management system. The POS device receives updated software from the terminal management system, and the update peripheral operation software is stored in memory. The peripheral operation software may comprise a peripheral driver that is stored in memory on the POS device. The peripheral operation software may comprise peripheral firmware that is sent to a peripheral connected to the POS device and store in memory comprised in the peripheral. The software update may be initiated by a user of the POS device or by the POS device itself. The peripheral device may be connected to the POS device wirelessly. The peripheral device may be external to the POS device, or may be integrated into the POS device. The peripheral device may be a contactless reader.

In another example embodiment, a POS device comprises a microprocessor system, memory addressable by the microprocessor system, a peripheral interface and a communication interface. The POS system is configured to receive updated peripheral operation software through the communication interface. A peripheral may be connected to the POS device, and may be connected wirelessly. The peripheral device may be a contactless reader. The updated peripheral operation software may comprise a peripheral driver that is stored in memory comprised in the POS device. The update peripheral operation software may comprise peripheral firmware that is sent to the peripheral device and stored in memory comprised in the peripheral device.

In another example embodiment, a payment system comprises a POS device, a peripheral device connected to the POS device through a peripheral link, and a terminal management system connected to the POS device through a communication link. The system is configured to update peripheral management software by sending a copy of a current version of the peripheral operation software from the terminal management system to the point of sale device over the communication link. The peripheral device may be a contactless reader. The communication link may be wireless. The peripheral link may be wireless. The peripheral operation software may comprise a peripheral driver that is stored in memory comprised in the POS device. The peripheral operation software may comprise peripheral firmware that is sent to the peripheral device and stored in memory comprised in the peripheral device. The peripheral device may be integrated into the POS device.

### BRIEF DESCRIPTION OF THE DRAWINGS

FIG. 1 shows a payment system in accordance with an example embodiment of the invention.

FIG. 2 shows a block diagram of a portion of the payment system of FIG. 1.

FIG. 3 shows a method of updating peripheral operation software, in accordance with an example embodiment of the invention.

### DETAILED DESCRIPTION OF THE INVENTION

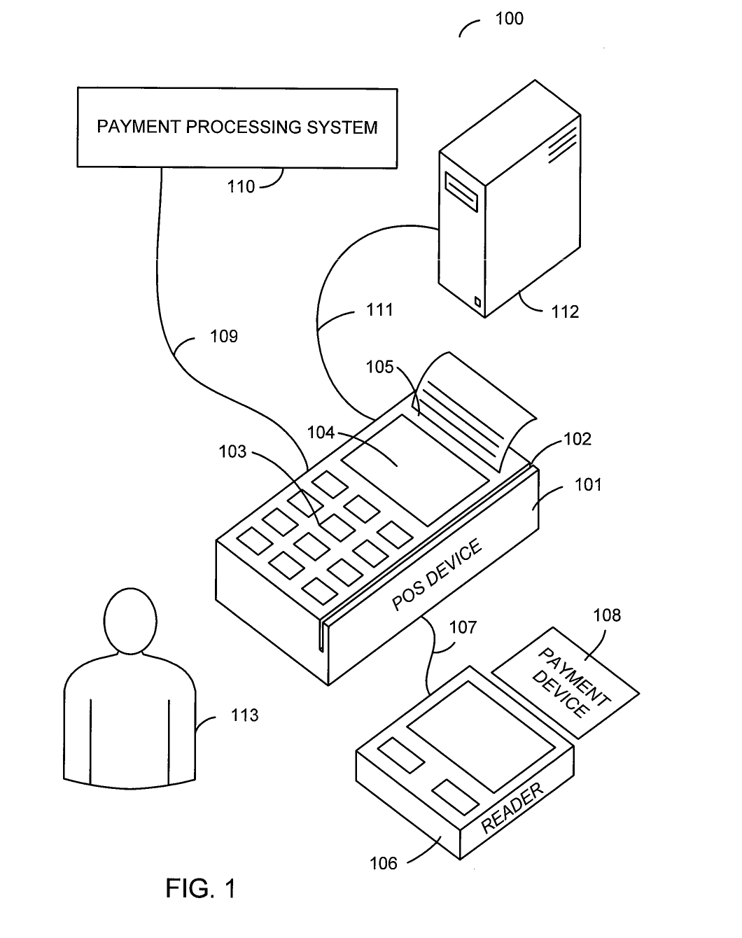

FIG. 1 shows a payment system 100 in accordance with an example embodiment of the invention. Payment system 100 comprises the components used in processing customer transactions.

Central to the system is a point of sale (POS) device 101. A POS device, also sometimes called a POS terminal, is a device used for processing payments at the point of sale. Example POS device 101 comprises a slot 102 through which credit, debit, gift, or other kinds of cards may be “swiped”. A keypad 103 allows a user 113 of the device to enter information, for example the credit card number of a card that has been damaged and is not readable by swiping it through slot 102. A display 104 displays messages, prompts, or other information to the operator of the device. A printer 105 may print receipts and other kinds of documents. A POS device in accordance with an example embodiment of the invention need not include all of the components of example POS device 101, or may include other features not included in example POS device 101.

Also included in payment system 100 is a peripheral device 106. A peripheral device is a hardware device that is not architecturally part of the main host device (POS device 101 in this example) and that can provide input to or accept output from the host device. Example peripheral device 106 is a reader for reading payment device 108, which in this example is a contactless payment device. Reader 106 is external to POS device 100 and connected through peripheral link 107. Peripheral link 107 may be, for example a wired or wireless connection that enables POS device 101 and peripheral device 106 to be in communication. In one example embodiment, POS device 101 and peripheral device 106 communicate through a universal serial bus (USB) connection, and peripheral link 107 is a USB cable. A peripheral device may also be integrated into POS device 101, but may be considered to be a peripheral based on the electronic architecture of POS device 101. For example, printer 105 may be a peripheral device, even though it is housed inside POS device 101. Microprocessor system 201 may communicate with a peripheral that is integrated into POS device 101 through a peripheral interface that is also integrated into POS device 101, using a driver stored in memory 202, just as if the peripheral were external to POS device 101.

A payment device is any device that stores customer account information and allows the customer to make payments. Example payment devices include credit cards, debit cards, gift cards, stored value cards, any of which may store account information on a magnetic stripe, in a memory, or by other means. Example payment device 108 is a contactless payment device. Contactless payment devices come in many forms, and may be cards, key fobs, keychain attachments, handheld devices such as mobile telephones, or other kinds of devices. The contactless payment device need only be able to store account information and communicate that information wirelessly to a compatible contactless reader. Often, this is accomplished using internal memory and a secure microcontroller or other equivalent intelligence.

Both reader 106 and payment device 108 have antennae, and the two communicate using radio frequencies. No physical contact between reader 106 and payment device 108 is required. Typically, reader 106 can read account information from payment device 108 from a distance. The maximum distance from which a reader can read a passive payment device is typically one-half inch to as much as three inches. If payment device 108 comprises a battery or other power source, longer working distances are possible.

In the example embodiment of FIG. 1, POS device 101 is connected through a link 109 to a payment processing system 110. Link 109 may be a wired connection or a wireless connection that enables POS device 101 and payment processing system 110 to be in communication. For example, link 109 may be a local area network (LAN), and wide area network (WAN) such as the Internet, the “plain old telephone system” (POTS), a wireless telephone connection, or another kind of link. Payment processing system 110 determines whether a customer has sufficient funds or credit to make the proposed purchase, and communicates the result to POS device 101. Payment processing system 110 may be a single computer or multiple computers in communication with each other.

POS device 101 is also connected through communication link 111 to a terminal management system 112. Communication link 111 may also be a wired connection or a wireless connection, and enables POS device 101 and terminal management system 112 to be in communication. For example, communication link 111 may be a local area network (LAN), and wide area network (WAN) such as the Internet, the “plain old telephone system” (POTS), a wireless telephone connection, or another kind of link. Terminal management system 112 provides information to POS device 101 relating to the operation and use of POS device 101 in a particular merchant environment. For example, terminal management system 112 may provide software application files, peripheral drivers, operating system updates, firmware updates, merchant demographic information, other kinds of information, or any of these in any combination.

Many different configurations are possible, within the scope of the appended claims. For example, payment processing system 110 and terminal management system 112 may be implemented on the same or different computer systems. Link 109 and communication link 111 may be part of the same or different networks, and may be of the same type or different types. Various parts of the system, for example POS device 101 and terminal management system 112, may reside at the same location, or may be separated by a wide distance. For example, terminal management system may be at a central location, and may serve many POS devices residing in many different cities. Similarly, payment processing system 110 may serve many POS devices in many locations.

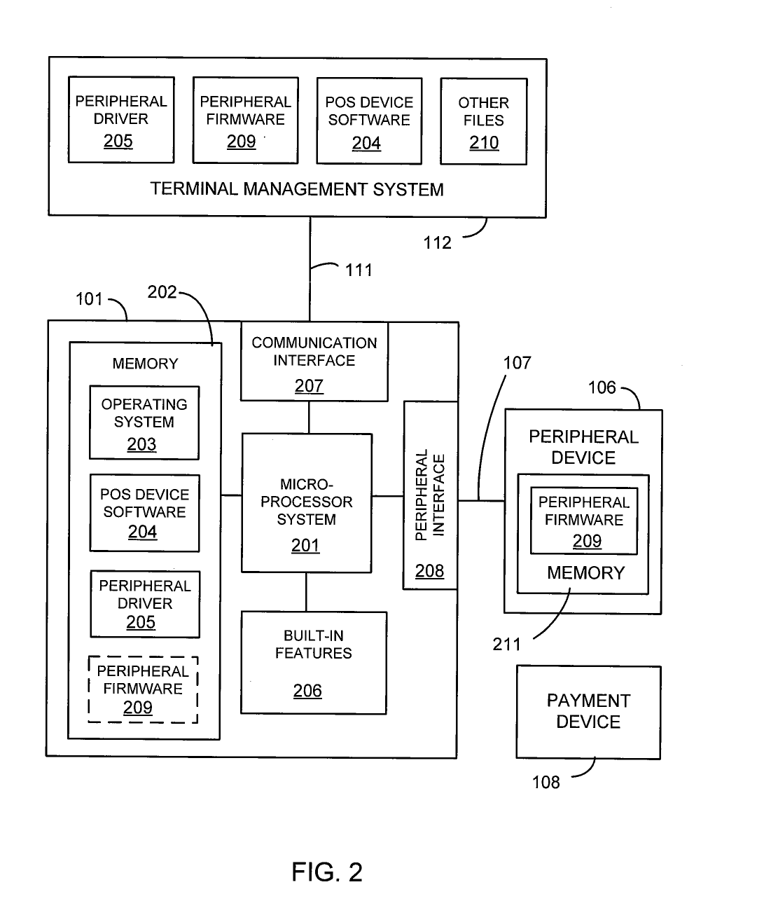

FIG. 2 shows certain parts of the system of FIG. 1 in block diagram form, according to an example embodiment of the invention. More internal detail of some components is visible in FIG. 2 than in FIG. 1. POS device 101 comprises a microprocessor system 201, which generally controls the operation of the system. Microprocessor system 201 may comprise, for example, an ARM9 microprocessor available from ARM Holdings PLC of Cambridge, United Kingdom, or one of the Intel x86 family of microprocessors available from Intel Corporation of Santa Clara, Calif., USA, or another kind of proprietary or commercially available microprocessor. Microprocessor system 201 is connected to memory 202, which is addressable by microprocessor system 201. Memory 202 may comprise volatile memory such as random access memory (RAM), may comprise nonvolatile memory such as read only memory (ROM), flash memory, programmable read only memory (PROM), erasable programmable read only memory (EPROM), may comprise other kinds of memory, or may comprise any combination of these.

Stored in memory 202 are various software components, which may comprise an operating system 203, POS device software 204, and a driver 205 for peripheral device 106. Operating system 203 generally monitors and controls the interactions of other components in the system, and may be, for example, the Windows CE operating system available from Microsoft Corporation of Redmond, Wash., USA, or another kind of proprietary or commercially available operating system. A driver is a section of code used to control the interaction with specific hardware components of the system or specific peripheral devices. Memory 202 may hold other drivers in addition to driver 205, the other drivers relating to other peripheral devices. For example, in addition to the components shown in FIGS. 1 and 2, POS device 101 may be connected to a bar code reader, a check reader, or other peripherals, and have drivers installed for them as well. Operating system 203 may “call” driver 205 with relatively high-level commands for peripheral device 106, and driver 205 may perform low-level, hardware specific tasks associated with sending the high-level commands to peripheral device 106. POS device software 204 may function as an application program that determines which device functions should be performed and in what order, and may interact with a user of POS device 101. Many other architectures are possible for the memory contents of POS device 101. For example, a POS device in accordance with an example embodiment of the invention may not use an operating system at all, and may comprise a single program that performs the functions of software 204 and operating system 203. For the purposes of this disclosure, operating system 203, driver 205, software 204, and any other computer instructions may be referred to individually or collectively as “software”, whether stored in volatile or nonvolatile memory.

Example POS device 101 may comprise various built-in features 206, which have been lumped together for clarity of illustration. These features may include a keypad, a display, a card-reading slot and magnetic card reader, or any of these and other features in any combination. Other aspects of PO device 101 have been omitted from the figures for clarity.

Example POS device 101 also comprises at least one communication interface 207 that enables connection to communication link 111. Communication interface 207 may be, for example, a modem that connects to the “plain old telephone system” (POTS). Or communication interface 207 may be an Ethernet connection for connecting to an electronic network such as the Internet, or interface 207 may be another kind of communication interface. POS device 101 may comprise more than one communication interface, and may comprise communication interfaces of various kinds in any combination. POS device 101 may use communication interface to exchange information with other computer systems, for example for payment processing system 110.

Example POS device 101 also comprises a peripheral interface 208. Peripheral interface 208 is preferably a Universal Serial Bus (USB) interface, but may be another kind of interface, such as a parallel interface, a serial interface, a proprietary interface, a standard interface, or another kind of interface. POS device 101 may comprise multiple peripheral interfaces, which need not be all of the same kind.

Peripheral device 106 is connected to POS device 101 through link 107 to peripheral interface 208. Peripheral device 106 may be, for example, a newly-developed contactless reader for use with a newly-developed contactless payment device. Because peripheral device 106 may add new capabilities to POS device 101, POS device 101 may lack a driver for communicating with peripheral device 106, and software 204 may lack instructions for interacting with peripheral device 106 or for interacting with a user of the system wishing to take advantage of the new capabilities. For example, peripheral device 106 may require a specific hardware protocol to be used with peripheral interface 108, and may require that a specific command set be used for interaction. Or, a user of the system may need to be informed about the status of the new peripheral device or be prompted to enter particular information, for example using a keypad on POS device 101.

Peripheral device 106 further comprises peripheral firmware 209, stored in memory 211 within peripheral device 106. Peripheral device 106 typically also comprises a microprocessor system, and peripheral firmware provides instructions for the operation of peripheral device 106. Peripheral firmware 209 may need to be updated periodically, in order to provide bug fixes, enhanced performance, new capabilities, and the like.

For the purposes of this disclosure, peripheral drivers and peripheral firmware will be referred to individually or collectively as “peripheral operation software”. For example, peripheral driver 205 is peripheral operation software, and peripheral firmware 209 is peripheral operation software, associated with peripheral device 106.

POS device 101 connects through communication interface 207 and communication link 111 to terminal management system 112. In this example, terminal management system 112 stores current versions of various software components used by POS device 101 and peripheral device 106, including current versions of POS device software 204, peripheral driver 205, and peripheral firmware 209. Terminal management system 112 may store numerous other files 210, including, for example, current software components for other models of POS device served by terminal management system 112, and other firmware for other kinds of peripherals connected to POS device 101 or other POS devices. Other files 210 may include a database indicating which files are used by which models of POS devices and peripherals.

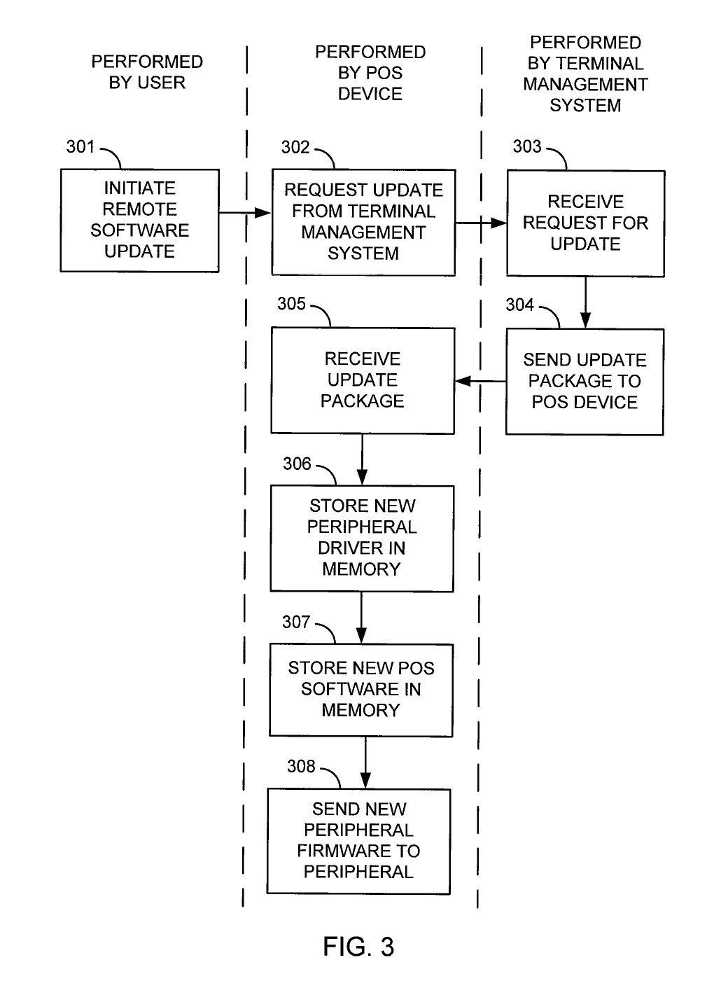

FIG. 3 illustrates a flowchart of a method in accordance with an example embodiment of the invention. In this example, POS device 101 receives updated software so that it can manage user interaction with the peripheral device, POS system 101 receives a driver to enable hardware communication with the peripheral device, and the peripheral device itself receives new firmware.

In step 301, a user of the POS device initiates a remote software update, for example using keystrokes on POS device 101. In step 302, POS device 101 contacts terminal management system 112 through communication link 111 and requests the needed software updates. In step 303, terminal management system 112 receives the update request. In step 304, terminal management system 112 sends an update package to POS device 101. The update package comprises copies of one of more of the current software components stored in terminal management system 112. At step 305, POS device 101 receives the package. In this context, the term “package” is to be interpreted broadly, and may mean a single file containing all of the required update components, or multiple files. In step 306, POS device 101 stores the updated peripheral driver 205 in memory 202. In step 307, POS device 101 stores the updated version of its own software in memory 202. In step 308, POS device 101 sends the updated version of peripheral firmware 209 to peripheral device 106 through peripheral link 107. Peripheral device 106 will install the updated peripheral firmware 209 in its own memory 211.

After the updated peripheral firmware has been sent to peripheral device 106, POS device 101 no longer has any need of the peripheral firmware 209 file, and may delete it from memory 202. The temporary nature of this file in memory 202 is depicted in FIG. 2 by a dashed outline of the block containing peripheral firmware 209.

The example software updates of FIG. 3 may be done in conjunction with installing new peripheral device on POS device 101, or the updates may be done at any time. Often, software, drivers, or firmware may be revised to implement bug fixes, enhance security, improve system performance, or the like. A user of POS device 101 may initiate a check for updates at any time. Preferably, during the request, POS device 101 informs terminal management system 112 of the software components installed on POS device 101. Terminal management system 112 checks a database to see if updated versions of any of the software components are available. If so, the update process may proceed in a manner similar to that shown in FIG. 3. Not all software components need be updated during every update cycle. Preferably, only those for which a new version is available are sent to POS device 101. For example, in one update, only peripheral firmware 209 may be updated. In another update, only peripheral driver 205 may be updated. In another update, POS software 204 and peripheral firmware 209 may be updated. Any combination is possible.

In accordance with another embodiment of the invention, POS device 101 contacts terminal management system 112 periodically to see if updates are available, without the need for a user to initiate the process. In this way, updates are not missed because a user forgets to check for updates. The periodic requests may be in conjunction with a periodic settlement of POS device 101.

The invention has now been described in detail for the purposes of clarity and understanding. However, those skilled in the art will appreciate that certain changes and modifications may be practiced within the scope of the appended claims.

1. A method of, operating a point of sale device, the method comprising:
reading, by the point of sale device, account identification information from a presentation instrument during a transaction;
requesting and receiving, by the point of sale device, transaction approval from a payment processing system;
requesting, by the point of sale device, an update of peripheral operation software from a terminal management system;
receiving, by the point of sale device, updated peripheral operation software from the terminal management system; and
storing the updated peripheral operation software in memory;
wherein the transaction approval and the updated peripheral operation software are requested from the same computer system, which computer system implements both the payment processing system and the terminal management system.

2. The method of claim 1, wherein the updated peripheral operation software comprises a peripheral driver for interacting with a peripheral device connected to the point of sale device, and wherein the updated peripheral driver is stored in memory comprised in the point of sale device.

3. The method of claim 1, wherein the updated peripheral operation software comprises peripheral firmware for a peripheral device connected to the point of sale device, the method further comprising:
sending the updated peripheral firmware to the peripheral device; and
storing the updated peripheral firmware in memory comprised in the peripheral device.

4. The method of claim 3, further comprising deleting a temporary copy of the updated peripheral firmware from memory comprised in the point of sale device.

5. The method of claim 1, wherein the request is initiated by a user of the point of sale device.

6. The method of claim 1, wherein the request is initiated by the point of sale device.

7. The method of claim 1, wherein the peripheral operation software is associated with a peripheral device that is connected to the point of sale device wirelessly.

8. The method of claim 1, wherein the peripheral operation software is associated with a peripheral device that is external to the point of sale device.

9. The method of claim 1, wherein the peripheral operation software is associated with a peripheral device that is integrated into the point of sale device.

10. The method of claim 1, wherein the requesting an update of peripheral management software from the terminal management system further comprises contacting the terminal management system through a wireless link.

11. The method of claim 1, wherein the peripheral operation software is associated with a contactless reader.

12. A point of sale device, comprising:
a microprocessor system;
memory addressable by the microprocessor system and storing software for the microprocessor system;
a peripheral interface; and
a communication interface;
wherein the point of sale system is configured to receive transaction approvals and updated peripheral operation software through the communication interface from the same remote computer system.

13. The point of sale device for claim 12, further comprising:
a peripheral device connected to the point of sale device through the peripheral interface, and with which the peripheral operation software is associated.

14. The point of sale device of claim 13, wherein the peripheral device is connected to the point of sale device wirelessly.

15. The point of sale device of claim 13, wherein the peripheral device is a contactless reader.

16. The point of sale device of claim 12, wherein the updated peripheral operation software comprises a driver for a peripheral connected to the point of sale device, and wherein the peripheral driver is stored in the memory of the point of sale device.

17. The point of sale device of claim 12, wherein the updated peripheral operation software comprises peripheral firmware for a peripheral device connected to the point of sale device, and wherein the peripheral firmware is sent to the peripheral device where it is stored in memory comprised in the peripheral device.

18. A payment system, comprising:
a point of sale device comprising a microprocessor system, memory, a communication interface, and a peripheral interface;
a peripheral device connected to the point of sale device through the peripheral interface and a peripheral link; and
a terminal management system storing current versions of peripheral operation software associated with the peripheral device, the point of sale device connected to the terminal management system through the communication interface and a communication link;
a payment processing system that receives account identification information read from a presentation instrument during a transaction by the point of sale device and returns transaction approval information to the point of sale device;
wherein the system is configured to update peripheral operation software by sending a copy of a current version of the peripheral operation software from the terminal management system to the point of sale device over the communication link;
and wherein the terminal management system and the payment processing system are implemented on the same computer system.

19. The payment system of claim 18, wherein the peripheral device is a contactless reader.

20. The payment system of claim 18, wherein the communication link is wireless.

21. The payment system of claim 18, wherein the peripheral link is wireless.

22. The payment system of claim 18, wherein the peripheral operation software comprises a peripheral driver, and wherein the updated peripheral driver is stored in the memory comprised in the point of sale device.

23. The payment system of claim 18, wherein the peripheral operation software comprises peripheral firmware, and wherein the updated peripheral firmware is sent to the peripheral over the peripheral link where it is stored in memory comprised in the peripheral device.

24. The payment system of claim 18, wherein the peripheral device is integrated into the point of sale device.

25. A method of updating software, the method comprising:
requesting, by a point of sale device, an update of peripheral operation software from a terminal management system;
receiving, by the point of sale device, updated peripheral operation software from the terminal management system; and
storing the updated peripheral operation software in memory;
wherein requesting the update of peripheral operation software from the terminal management system is performed in conjunction with a periodic settlement performed by the point of sale device.
